(19) United States
(12) Patent Application Publication
(10) Pub. No.: US 2024/0281911 A1
(43) Pub. Date: Aug. 22, 2024

(54) PRINTER AND METHOD FOR CONTROLLING PRINTER

(71) Applicant: CANON KABUSHIKI KAISHA, Tokyo (JP)

(72) Inventor: HISASHI TERAE, Tokyo (JP)

(21) Appl. No.: 18/443,034

(22) Filed: Feb. 15, 2024

(30) Foreign Application Priority Data
Feb. 20, 2023 (JP) 2023-024364

(51) Int. Cl. G06Q 50/18; G06F 3/12

(52) U.S. Cl. CPC G06Q 50/18; G06F 3/1204; G06F 3/1224; G06F 3/1239; G06F 3/1288

(57) ABSTRACT

A printer issues an alert when the remaining number of prints up to the upper limit number of prints according to the subscription contract is reduced. The printer displays a screen for requesting to change a contract or perform an additional charge for increasing the upper limit number of prints in the offline state when the number of prints reaches the upper limit number of prints in the offline state. Then, the printer updates the held contract information in response to the request for changing the contract or the request for an additional charge, and displays a message indicating that the printer should be connected to the server within a certain business day or within the contract period. Thereafter, if the printer is not connected to the server within the certain business day or within the contract period, the printer restricts printing.

### BACKGROUND OF THE DISCLOSURE

### Field of the Disclosure

The present disclosure relates to a printer and a method for controlling printer.

### Description of the Related Art

An image processing apparatus records (prints) an image on a recording sheet by attaching a recording agent to the recording sheet. It is a complicated operation for a user to purchase and manage consumables such as toner and cartridges filled with the recording agent by the user in order to use the apparatus. For this reason, in recent years, a subscription service has been provided that specify an upper limit number of prints during a contract period and deliver consumables. In the subscription service, it is necessary for the server to manage the usage status of consumables in the image processing apparatus, the number of prints during the contract period, contract information, etc.

It is essential that the image processing apparatus is connected to the network in order to perform the management on the server. When the image processing apparatus is not connected to the server, it is impossible for the server to properly manage the image processing apparatus, and there is a possibility of illegal use on the user side.

Japanese Patent Application Laid-Open No. 2017-47590 proposes a technique for restricting printing by detecting that the image processing apparatus does not communicate with the server.

Japanese Patent Application Laid-Open No. 2017-47590 describes a technique that prevents the usage of devices and suppresses unauthorized use by making it impossible to pay charges when the device is not in communication with the server. However, even when the server itself is down, or when communication with the server is not possible due to problems with the communication line or Wi-Fi, printing is restricted, which is inconvenient for the user. In particular, in the case of a subscription service, there was a problem that the benefit of the user was significantly reduced by a period of time during which printing could not be performed.

### SUMMARY OF THE DISCLOSURE

The present disclosure relates to a printer for communicating with a server that manages contract information of a contract for permitting printing up to a predetermined upper limit number of prints corresponding a specified amount during a contract period, the printer comprising at least one processor and at least one memory storing instructions to be executed by the processor to cause the printer to operate as: a first management unit that acquires and manages the contract information from the server; a control unit that controls to perform printing based on the contract information; a second control unit that manages cumulative number of prints within the contract period, a remaining number of prints up to the upper limit number of prints, the number of days since the printer has been in offline state with no connection to the server, and the number of prints in the offline state; an alert unit that issue an alert message when the remaining number of prints up to the upper limit number of prints is less than a predetermined number; a first display unit that, when the number of prints reaches the upper limit number of prints in the offline state, displays a screen for requesting to change the contract or to perform an additional charge for increasing the upper limit number of prints in the offline state; an updating unit that updates the contract information managed by the first management unit in response to a request input via the screen; a second display unit that displays a message indicating that the printer should be connected with the server within a certain business day or within the contract period in response to updating the contract information; and a restriction unit that restricts printing when the server is not connected within the certain business day or within the contract period after updating the contract information.

Further features of the present disclosure will become apparent from the following description of exemplary embodiments with reference to the attached drawings.

### BRIEF DESCRIPTION OF THE DRAWINGS

FIG. 1 is a diagram illustrating an entire system according to one or more aspects of the present disclosure.

FIG. 2 is a diagram illustrating a hardware configuration of an image processing apparatus according to one or more aspects of the present disclosure.

FIG. 3 is a diagram illustrating a hardware configuration when an information terminal and the server according to one or more aspects of the present disclosure are realized by a general information processing apparatus.

FIG. 4 is a diagram illustrating a software configuration of the image processing apparatus according to one or more aspects of the present disclosure.

FIG. 5 is a diagram illustrating a software configuration of an application operating on the server according to one or more aspects of the present disclosure.

FIG. 6 is a sequence diagram illustrating a processing flow between the information terminal, the image processing apparatus and the server according to one or more aspects of the present disclosure.

FIG. 7A is a flowchart explaining the details of a printing process in offline state according to the first embodiment.

FIG. 7B is a flowchart explaining the details of a determination process of return to online state from offline state according to one or more aspects of the present disclosure.

FIG. 8 is a diagram illustrating a screen displayed when an offline state is detected according to one or more aspects of the present disclosure.

FIG. 9 is a diagram illustrating a screen displayed when printing is performed in offline state according to one or more aspects of the present disclosure.

FIG. 10 is a diagram illustrating a screen displayed when the number of prints reaches the upper limit number of prints in offline state and a contract change is proposed according to one or more aspects of the present disclosure.

FIG. 11 is a diagram illustrating a screen displayed when the contract change is completed in offline state according to one or more aspects of the present disclosure.

FIG. 12 is a diagram illustrating a screen displayed when a procedure for additional charges is completed in the offline state according to one or more aspects of the present disclosure.

FIG. 13 is a diagram illustrating a screen displayed when the usage restriction is performed due to not connecting to the server for a certain period after a procedure of changing the contract or performing an additional charge in the offline state according to one or more aspects of the present disclosure.

FIG. 14 is a diagram illustrating a screen displayed on the information terminal according to one or more aspects of the present disclosure when information on the image processing apparatus in offline state is checked on a website of the server.

FIG. 15 is a flowchart explaining the details of a determination process of return to online state from offline state according to one or more aspects of the present disclosure.

FIG. 16 is a diagram illustrating a screen displayed in the offline state according to one or more aspects of the present disclosure.

FIG. 17 is a sequence diagram illustrating a processing flow between an information terminal, an image processing apparatus and a server according to one or more aspects of the present disclosure.

FIG. 18 is a diagram illustrating a screen displayed on the information terminal in the third embodiment when canceling a subscription contract of the image processing apparatus under the offline state is performed on the homepage of the server.

FIG. 19 is a diagram illustrating a screen displayed in the third embodiment when trying to cancel a contract is performed after a procedure of changing the contract or performing an additional charge in the offline state.

FIG. 20 is a flowchart explaining the details of a determination process of return to online state from offline state according to one or more aspects of the present disclosure.

FIG. 21 is a diagram illustrating an example of a screen displayed according to one or more aspects of the present disclosure when the usage restriction is postponed because the printer is not able to connect to the server due to the server after a procedure of changing the contract or performing additional charges.

FIG. 22 is a diagram illustrating a two-dimensional barcode that is displayed according to one or more aspects of the present disclosure when the number of prints reaches an upper limit number of prints in the offline state and is used for accessing the server's homepage.

### DESCRIPTION OF THE EMBODIMENTS

Hereinafter, an embodiment of the present disclosure will be described with reference to the drawings.

### First Embodiment

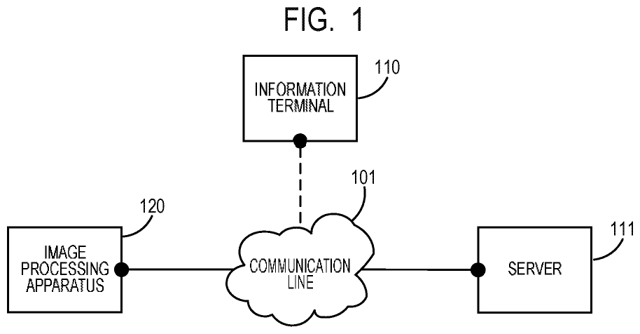

FIG. 1 is a diagram illustrating an entire system according to the embodiment of the present disclosure. An information terminal 110, a server 111, and an image processing apparatus 120 are connected via a communication line 101 such as the Internet.

The information terminal 110 is a personal computer (PC), a mobile device, a tablet, or the like. The image processing apparatus 120 is a multifunction machine, a printer, or the like capable of using a part or a plurality of functions such as printing, scanning, and faxing. The image processing apparatus 120 and the information terminal 110 can always communicate with the server 111 via a communication line 101. Further, the server 111 monitors the image processing apparatus 120 by collecting information from the image processing apparatus 120, and can receive requests from the information terminal 110 and perform a process.

The server 11 according to the present embodiment manages contract information for a contract (subscription contract) that permits printing up to a predetermined upper limit number of prints during a contract period (e.g., one month) by paying a fixed amount. The image processing apparatus 120 according to the present embodiment is a printer corresponding to the subscription contract.

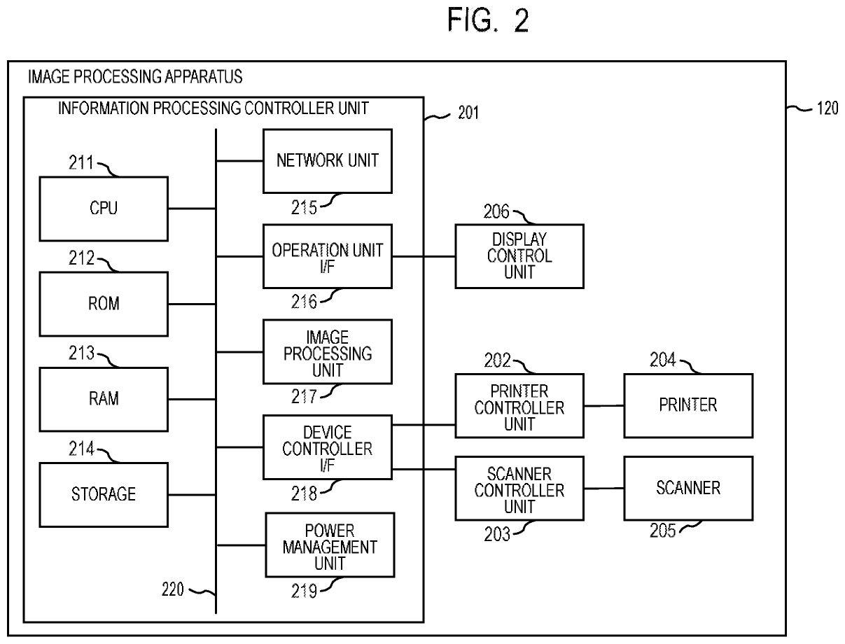

FIG. 2 is a diagram illustrating a hardware configuration of the image processing apparatus 120 according to the present embodiment. The image processing apparatus 120 includes an information processing controller unit 201, a printer controller unit 202, a scanner controller unit 203, a printer 204, a scanner 205, and a display operation unit 206.

The information processing controller unit 201 is a controller that supervises information processing control related to the operation of the image processing apparatus 120, and is connected to the display operation unit 206. Further, the printer controller unit 202 and the scanner controller unit 203 are connected to the information processing controller unit 201. The printer controller unit 202 controls the printer 204 which is an image output device. The scanner controller unit 203 controls a scanner 205 which is an image input device.

The information processing controller unit 201 has a CPU 211. The CPU 211 starts an OS (operating system) by a boot program stored in the ROM 212. The CPU 211 executes an application program stored in the storage 214 on the OS and executes various processes by this application program. The RAM 213 is used as a work area of the CPU 211. The RAM 213 provides the work area and an image memory area for temporarily storing image data.

The storage 214 stores the application program, image data, various setting values and history information. The storage 214 is composed of, for example, a storage device such as a hard disk drive (HDD), a solid state drive (SSD), and an embedded MultiMediaCard (eMMC). The storage 214 may be configured to use these storage devices together.

An operation unit I/F 216, a device controller I/F 218, a network unit 215, an image processing unit 217, and a power management unit 219 are connected to the CPU 211 through a system bus 220, together with the ROM 212, the RAM 213, and the storage 214.

The operation unit I/F 216 is an interface with the display operation unit 206 having a touch panel and a numeric keypad. The operation unit I/F 216 outputs image data to be displayed on the display operation unit 206 to the display operation unit 206. The operation unit I/F 216 also transmits information inputted by the user via the display operation unit 206 to the CPU 211.

The printer controller unit 202 and the printer controller unit 202 are connected to the device controller I/F 218, and the device controller I/F 218 performs synchronous/asynchronous conversion of image data.

The network unit 215 is connected to the communication line 101. The network unit 215 inputs and outputs information to and from each device on the communication line 101.

The image processing unit 217 performs processing such as output image processing to the printer 204, input image processing from the scanner 205, image rotation, image compression, resolution conversion, color space conversion, and gradation conversion.

The power management unit 219 performs power control of the entire device. In addition to power on-off control, the power management unit 219 controls the transition from a normally energized state to a power-saving state other than the normally energized state, and the return from the power-saving state to the normally energized state.

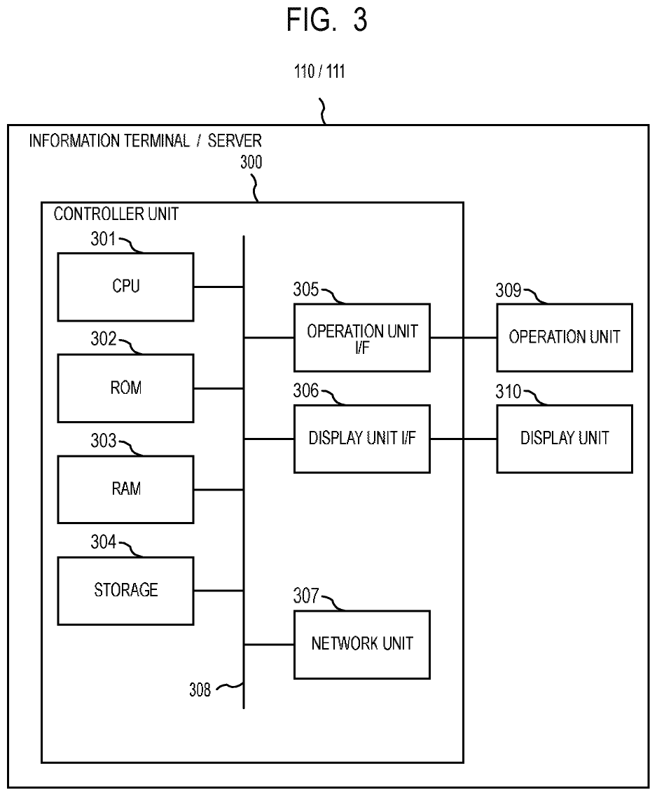

FIG. 3 is a diagram illustrating a hardware configuration when an information terminal and the server are realized by a general information processing apparatus. Since there is no significant difference between the main configurations of the information terminal 110 and the server 111, these devices will be described together. However, the server 111 may be realized by one computer or a plurality of computers. For example, the server 111 may be realized using cloud computing technology.

The information terminal 110 and the server 111 include a controller unit 300, an operation unit 309, a display unit 310, and the like as hardware. The controller unit 300 includes a CPU 301. The CPU 301 starts an OS by a boot program stored in the ROM 302. The CPU 301 executes an application program stored in the storage 304 on the OS and executes various processes by the application program. The RAM 303 is used as a work area of the CPU 301.

The storage 304 stores the application program and data such as settings and history information. The storage 304 may be, for example, a storage device such as an HDD, an SSD, and an eMMC. The storage 304 may include these storage devices. An operation unit I/F 305, a display unit I/F 306, and a network unit 307 are connected to the CPU 301 through a system bus 308, together with the ROM 302, the RAM 303, and the storage 304.

The operation unit I/F 305 is an interface with the operation unit 309 consisting of a touch panel, a keyboard, and a mouse. The operation unit I/F 305 transmits information inputted by the user via the operation unit 309 to the CPU 301.

The display unit I/F 306 outputs image data to be displayed on the display unit 310 consisting of a display to the display unit 310. The network unit 307 is connected to the communication line 101 and inputs and outputs information to and from each device on the communication line 101.

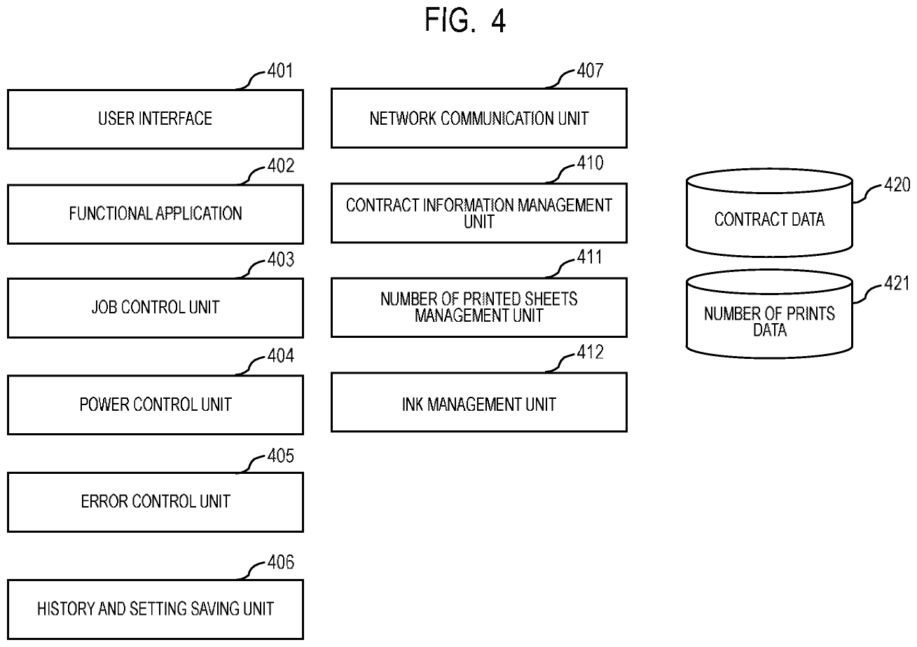

FIG. 4 is a view illustrating a software configuration of the image processing apparatus 120 according to the present embodiment. In the image processing apparatus 120, software for realizing various functionalities using scanning, printing, and network and memory storage is operated. The components illustrated in FIG. 4 are realized by the CPU 211 executing a program stored in a storage device of either the RAM 213, the storage 214, or the ROM 212, and realize the following functions.

The user interface 401 has a function of displaying a screen to be operated by the user to the display operation unit 206 and transmitting the movement to the software when the user operates the screen.

There are several functional applications 402 in the device for copying, printing, sending e-mails, etc. The functional applications 402 operate the application functions of the image processing apparatus by triggering user instructions via the display operation unit 206 or data receiving via the network.

A job control unit 403 controls the printer controller unit 202 and the scanner controller unit 203 to execute scanning and printing in response to the instruction from the functional application 402.

The power control unit 404 controls the power supply management unit 219 in conjunction with the state of the software in the device, and controls the transition between the normally energized state and the power-saving state.

The error control unit 405 receives the notification of the abnormal state mainly generated by the job control unit 403, the printer controller unit 202, the scanner controller unit 203, etc., and performs the control to stop the whole system or to instruct the degenerate operation.

A history and setting saving unit 406 manages the non-volatile information in the apparatus. For example, the history and setting saving unit 406 saves the settings necessary for controlling the image processing apparatus 120 and the job, and also stores the user's operation history, the job execution result, and the occurrence of an error in a summarized manner. The history and setting saving unit 406 also stores log information to be left for analysis debugging when a system failure occurs.

A network communication unit 407 communicates with the server 111 and the information terminal 110 connected via the communication line 101. The network communication unit 407 receives a copy/scan execution request or an import request from the information terminal 110, and instructs the functional application 402 to execute the job.

A contract information management unit 410 manages contract information of a subscription acquired from a server 111 via the network communication unit 407 and stored in contract data 420.

A number of prints management unit 411 has a function of counting the number of prints by job execution from the job control unit 403 and saving them in a number of prints data 421, and a function of comparing the number of prints with the upper limit of printing in the contract stored in the contract data 420. The number of prints management unit 411 also has a function of managing the number of days since the printer has been in offline state. The number of prints management unit 411 manages cumulative number of prints within the contract period, a remaining number of prints up to the upper limit number of prints, the number of days since the printer has been in offline state, and the number of prints in the offline state, respectively. The contract data 420 and the number of prints data 421 are stored in the storage 214.

The ink management unit 412 acquires and manages an ink state consumed during printing from the printer controller unit 202, and notifies the server 111 of the ink state at a fixed frequency via the network communication unit 407.

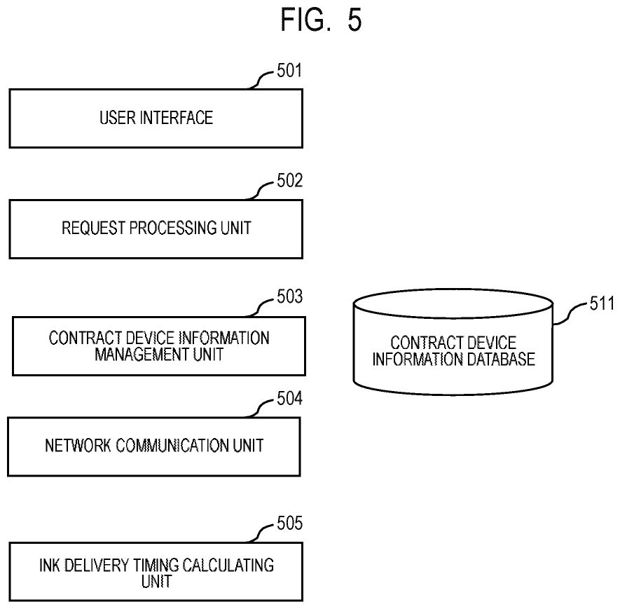

FIG. 5 is a diagram illustrating a software configuration of an application operating on the server 111. The components illustrated in FIG. 5 are realized by the CPU 301 of the server 111 executing a program stored in one of the storage devices of the RAM 303, the storage 304, and the ROM 302 of the server 111, and realize the following functions.

A user interface 501 has a function of displaying a screen operated by the user via the operation unit 309 of the server 111 on the display unit 310, and a function of transmitting the movement of the screen to the software when the user operates the screen.

A request processing unit 502 has a function of processing a processing request received by the network communication unit 504 from the information terminal 110 and the image processing apparatus 120 via the communication line 101.

A contract device information management unit 503 registers information of the subscription contract made by the user for each image processing apparatus 120 in the contract device information database 511 and manages the information. The procedure for the subscription contract is performed according to the guidance by the user at the display operation unit 206 of the image processing apparatus 120 and the operation unit 309 of the information terminal 110, and the information of the subscription contract is transmitted to the contract device information management unit 503 via the communication line 101. The contract device information management unit 503 registers the information of the subscription contract in the contract device information database 511.

An ink delivery timing calculating unit 505 calculates a time for delivering the replacement new ink to the user on the basis of the ink state notified from the ink management unit 412 of the image processing apparatus 120. When the ink delivery timing calculating unit 505 receives a notification of the ink state from the ink management unit 412 of the image processing apparatus 120, the ink delivery timing calculating unit 505 calculates the ink replacement time based on the ink consumption. When the replacement time is near, the necessity of the delivery of new ink is displayed on the display unit 310 of the server 111, and the network communication unit 407 notifies the information terminal 110.

Next, a subscription service assumed in the present embodiment will be described by using an example.

The subscription service assumed in the present embodiment is basically a contract in which a user is allowed to perform printing up to a specified number of prints within a contract period of each month or year in exchange for paying a fixed amount of money for a single image processing apparatus owned by one user. The subscription service also includes automatic delivery of replacement ink cartridges for ink cartridges whose remaining amount has decreased while the image processing apparatus 120 is in use. Accordingly, upon receiving a transmission request or directly, the server 111 transmits the contract information to the image processing apparatus 120. Then, the image processing apparatus 120 transmits information on the current number of prints and the remaining amount information of the ink cartridge to the server 111.

Also, the subscription is provided with a plurality of plans according to an amount used by the user. The user can request for changing plans.

For example, assume that the user's current subscription plan is Plan A, and the upper limit number of prints is 25 sheets per month and the payment is 125 yen. Then, assume that Plan B, one higher than Plan A, is 100 sheets per month and the payment is 500 yen. If a user changes to Plan B at the middle of the month in consideration of his/her print usage and pays an additional 375 yen of the difference, Plan B is applied from the next month onwards.

On the other hand, if the amount of print usage increases during the contract period but the usage is temporary, it is possible to increase the upper limit number of prints only during the contract period by paying an additional charge instead of changing the plan. The number of prints added by paying the additional charge varies depending on the contract.

For example, Plan A allows the user to print an additional 10 sheets for an additional payment of 140 yen. Plan B allows the user to print an additional 20 sheets for an additional payment of 140 yen. The correspondence to the change of the contract contents and the payment of the additional charge is generally made in online state when the image processing apparatus 120 and the server 111 are connected. In the present embodiment, such correspondence can be made even in the offline state. This configuration will be described below.

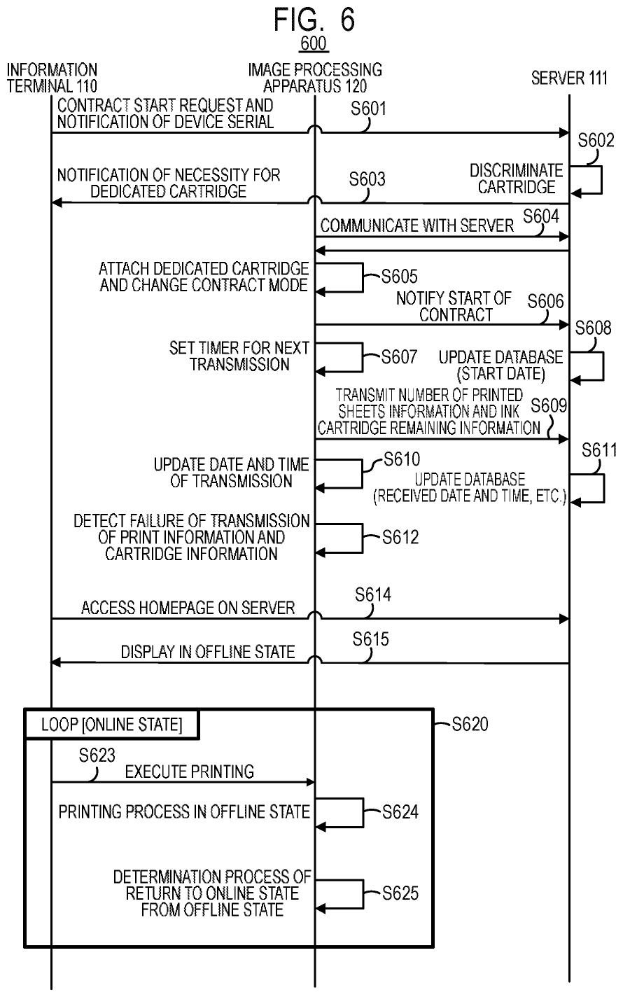

FIG. 6 is a sequence diagram illustrating the flow of processing between the information terminal 110, the image processing apparatus 120, and the server 111 according to the first embodiment. FIG. 6 corresponds to the flow of starting a subscription contract, communicating printing information and ink information, and detecting offline state.

Each processing of the information terminal 110 is realized by executing a program stored in one of the storage devices of the RAM 303, the storage 304, and the ROM 302 of the information terminal 110 by the CPU 301 of the information terminal 110. Each processing of the server 111 is realized by executing a program stored in one of the storage devices of the RAM 303, the storage 304, and the ROM 302 of the server 111 by the CPU 301 of the server 111. Each process of the image processing apparatus 120 is realized by the CPU 211 executing a program stored in one of the storage devices of the RAM 213, the storage 214, and the ROM 212.

The subscription contract will be described as being executed by switching from a state in which a device (such as the image processing apparatus 120) purchased as a commercial product is used as is (normal use mode) to a state in which a subscription contract is made (subscription mode).

In step S601 of the sequence 600, the user has a subscription contract for the image processing apparatus 120 owned by the user. Therefore, the user transmits information necessary for the subscription contract to the server 111 via the web browser of the information terminal 110, and requests for starting the subscription contract. The information necessary for the contract includes, for example, a payment method, an address of the user for cartridge delivery, the model of the device to be covered by the subscription contract, and a unique ID (serial number of the device).

When the server 111 receives the information necessary for the contract from the information terminal 110, the server 111 specifies the cartridge to be used by the user based on the model of the device in step S602. In the subscription contract, it may be necessary to install a cartridge corresponding to the subscription contract which can monitor the ink condition, etc. On the other hand, some cartridges can be used in both subscription mode and normal use mode. Therefore, the server 111 determines whether it is necessary to deliver a cartridge dedicated to subscription to the user. The determination method at this time includes a method of registering the model of the image processing apparatus and the cartridge information specified by the model in the contract device information database 511 managed by the server 111, and then determining whether the type of cartridge specified by the model can correspond to the subscription.

Next, in step S603, the server 111 transmits information on the necessity of the dedicated cartridge determined in step S602 to the information terminal 110, and makes the display unit 310 of the information terminal 110 display the information, and informs the user of the information. At this time, if the replacement with the dedicated cartridge is necessary, the image processing apparatus 120 notifies the user that the user is asked to wait until the dedicated cartridge is delivered. On the other hand, if the image processing apparatus 120 can be used in the subscription mode as it is, the image processing apparatus 120 notifies the user of the procedure for changing to the subscription mode.

In step S604, when the image processing apparatus 120 is connected to the communication line 101 and can communicate with the server 111, the server 111 instructs the image processing apparatus 120 to switch to the subscription mode. The method of connection in this case is that the server 111 may search the image processing apparatus 120 whose serial number is the same as the device's serial number acquired in step S601 or the image processing apparatus 120 may issue a connection request to the address of the server 111.

Next, in step S605, when the image processing apparatus 120 performs attaching the dedicated cartridge for subscription or changing to a contract mode by a specific procedure, the image processing apparatus 120 detects the action and changes from the normal use mode to the subscription mode.

Next, in step S606, the image processing apparatus 120 notifies the server 111 that the usage mode has been changed to the subscription mode and the use on the basis of the subscription contract has started (contract start notification).

When the subscription mode is started, in step S607, the image processing apparatus 120 sets a timer for transmitting information to the server 111 in a fixed cycle. Here, the image processing apparatus 120 communicates with the server 111 in a fixed cycle, but communication may be triggered when, for example, the printer controller unit 202 detects a printing operation in the printer 204. Alternatively, notification may be triggered when the current number of prints counted by the number of prints management unit 411 is detected to have increased by a fixed amount. Even if the period is not a certain period, for example, the ink management unit 412 may check the ink consumption speed and control to shorten the period when the ink consumption is large.

On the server 111 side, when receiving the start notification of using the subscription contract from the image processing apparatus 120, the contract device information management unit 503 updates the contract start date and time of the management information of the contract device information database 511 corresponding to the image processing apparatus 120 in step S608. For example, the contract start notification in step S606 may also serve as a request to acquire contract information. In response to the contract start notification in step S606, the server 111 may transmit subscription contract information corresponding to the image processing apparatus 120 in the contract device information database 511 to the image processing apparatus 120. Upon receiving the contract information, the image processing apparatus 120 stores and manages the contract information in the contract data 420.

Thereafter, in step S609, the image processing apparatus 120 transmits print number information and ink cartridge remaining information to the server 111 when the next information transmission timing is reached, such as when the time of the timer set for itself is reached. Specifically, the network communication unit 407 collects the ink cartridge remaining information from the ink management unit 412, collects the number of prints information from the number of prints management unit 411, and transmits the collected information to the server 111 via the communication line 101.

On the server 111 side, when the network communication unit 504 receives the information from the image processing apparatus 120 in step S611, the network communication unit 504 requests the contract device information management unit 503 to update the current number of prints information, the ink cartridge remaining information, and the latest received date and time of the image processing apparatus 120 stored in the contract device information database 511. Also, the network communication unit 504 responds to the image processing apparatus 120 that the information from the image processing apparatus 120 has successfully received.

On the image processing apparatus 120 side, when a response is received from the server 111 and it is confirmed that the transmission has been successfully carried out to the server 111, the network communication unit 407 requests the contract information management unit 410 to update the latest transmission date and time information of the contract data 420 in step S610.

The above is an explanation of the case where the image processing apparatus 120 and the server 111 can communicate normally. The following is an explanation of the case where the image processing apparatus 120 and the server 111 can no longer communicate (offline state).

As illustrated in step S609, the network communication unit 407 communicates with the server 111. However, when the response from the server 111 cannot be received even after a certain time has elapsed, the image processing apparatus 120 determines that the response has not been reached to the server 111 in step S612 (detecting failure of transmission). The reason why the response has not been reached may be, for example, that the network unit 215 is blocked from the communication line 101, or that the network unit 307 has failed to connect to the server 111, for example. At this time, the network communication unit 407 determines that the server 111 is in offline state when the response cannot be reached even after several retries.

On the other hand, when the connection between the server 111 and the image processing apparatus 120 is not possible, the user may attempt to log in to the server 111 with a web browser and browse a website of the server 111 by operating the operation unit 309 of the information terminal 110 (S614).

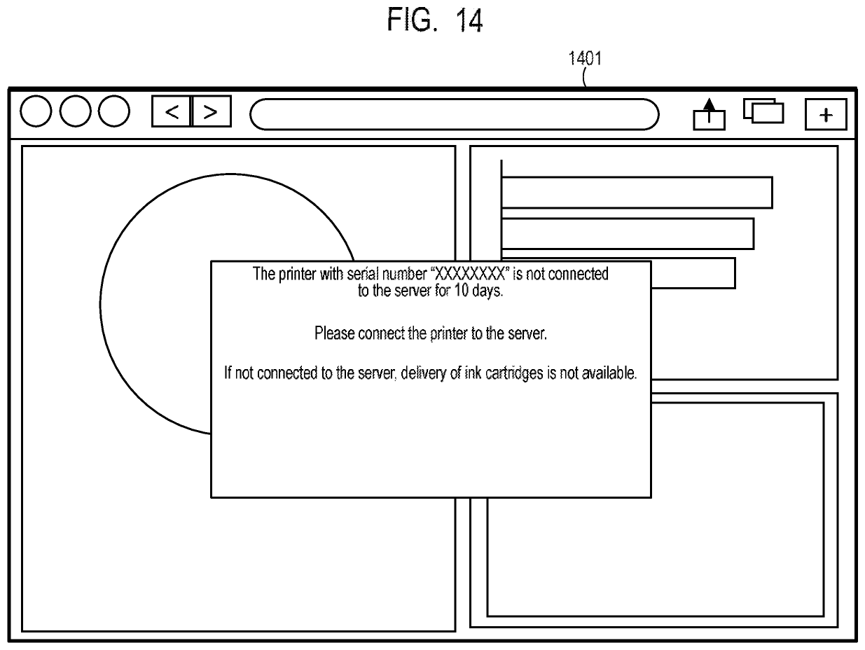

When there is the website browsing request from the information terminal 110, the request processing unit 502 of the server 111 specifies the ID of the user from the request message of the request. Then, the contract device information management unit 503 acquires the device ID of the image processing apparatus 120 associated with the user's ID from the contract device information database 511, and passes the information of the image processing apparatus 120 to the request processing unit 502. In step S615, the request processing unit 502 returns the information of the image processing apparatus 120 to the information terminal 110 via the network communication unit 504, and displays the information of the image processing apparatus 120 on the web browser screen of the display unit 310 of the information terminal 110. The contents displayed here are illustrated in the display screen 1401 of FIG. 14.

FIG. 14 is a diagram illustrating a screen displayed on the display unit 310 of the information terminal 110 when the information of the image processing apparatus 120 in the offline state is checked on the website of the server 111.

The display screen 1401 displays the serial number of the image processing apparatus 120 and the number of days that the image processing apparatus 120 is in offline state. The number of days that the image processing apparatus is in offline state is calculated from the last received date and time based on the image processing apparatus 120 recorded in the contract device information database 511 and the current time. In addition, it is indicated that automatic delivery of the ink cartridge, which is a service of the subscription contract, is not available while the image processing apparatus is in offline state, thereby giving a warning against being in offline state.

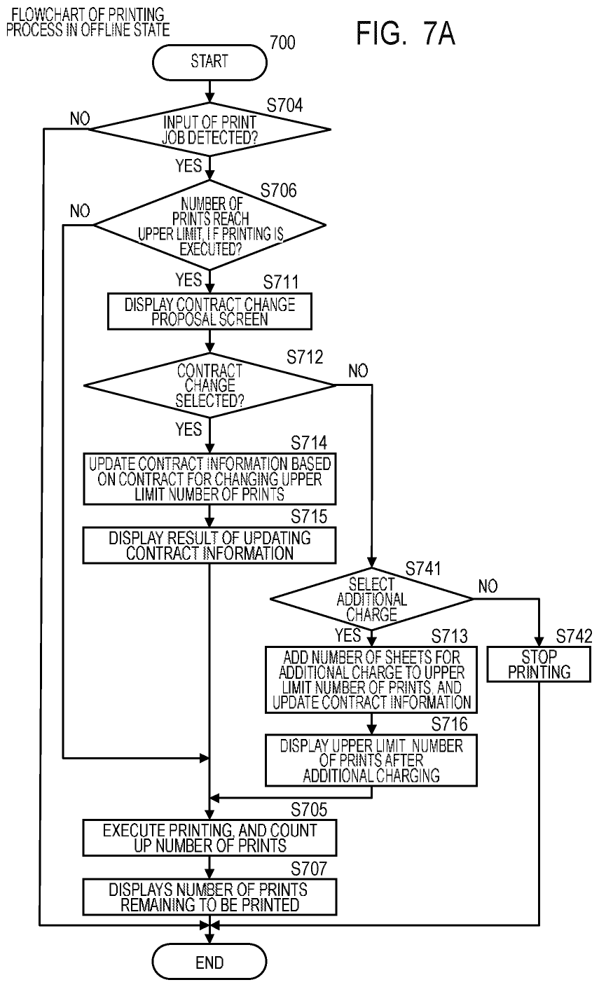

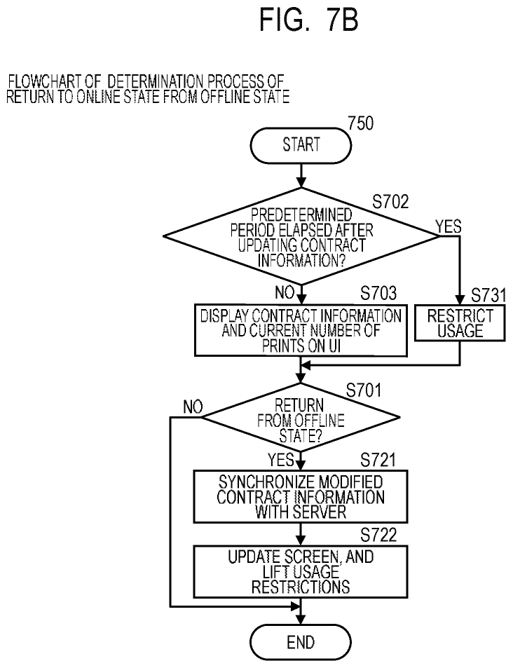

The sequence after the image processing apparatus 120 becomes offline state is illustrated in step S620. After the image processing apparatus 120 becomes offline state, as illustrated in step S623, a print job may be input from the information terminal 110. The processing (printing process in offline state) of the image processing apparatus 120 that enables processing for the print job is illustrated in step S624. The processing (determination processing of return from offline state) that determines whether the image processing apparatus 120 has returned from the offline state to the online state is illustrated in step S625. These details will be described in detail in a flowchart 700 of FIG. 7A and a flowchart 750 of FIG. 7B. It should be noted that steps S624 and S625 are repeatedly executed as long as the image processing apparatus 120 is in the offline state, and are terminated when the image processing apparatus 120 returns to the online state.

As described above, the image processing apparatus 120 can start usage based on the subscription contract. The image processing apparatus 120 can detect when the image processing apparatus 120 becomes offline state.

Referring to the flowcharts of FIG. 7A and FIG. 7B, the printing process in offline state (step S624 in FIG. 6) and the determination process of return from offline state (step S625 in FIG. 6) will be described below. The process of each flowchart of FIG. 7A and FIG. 7B is realized by the CPU 211 executing a program stored in one of the storage devices of the RAM 213, the storage 214, and the ROM 212 of the image processing apparatus 120.

First, the printing process in offline state will be described. FIG. 7A (700) is a flowchart describing the details of the printing process in offline state regarding step S624 of FIG. 6, which corresponds to the processing for a print job that is input when the image processing apparatus 120 goes offline state, and is repeatedly executed as long as it is in the offline state.

First, in step S704, the image processing apparatus 120 determines whether the print job has been input from the information terminal 110 to the job control unit 403 while the offline state is continued. If it is determined here that no print job has been input (No in step S704), the image processing apparatus 120 terminates the processing of this flowchart. On the other hand, if it is determined that the print job has been input (Yes in step S704), the image processing apparatus 120 proceeds the processing to step S706.

In step S706, the number of prints management unit 411 of the image processing apparatus 120 calculates the total number of prints obtained by adding the scheduled number of prints of the print job input to the job control unit 403 and the cumulative number of prints in the contract currently stored in the number of prints data 421. Then, it is determined whether the total number of prints exceeds the upper limit number of prints specified by the subscription contract stored in the contract data 420.

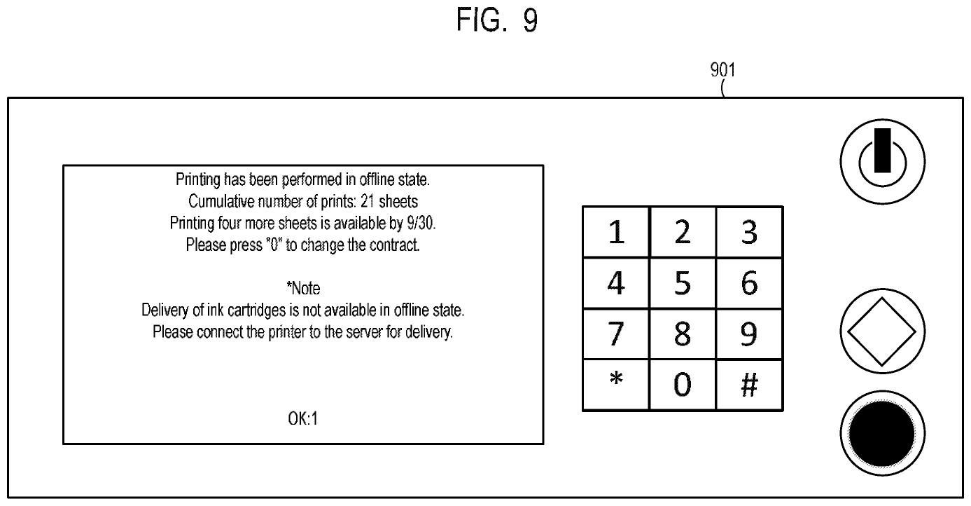

When the upper limit number of prints is not exceeded (the upper limit is not reached) (the case of No in step S706), the image processing apparatus 120 proceeds the processing to step S705. In step S705, the job control unit 403 instructs the printer controller unit 202 to execute printing, and the number of prints management unit 411 counts up the number of prints stored in the number of prints data 421. In step S707, the user interface 401 displays the number of prints that can be printed under the current contract to the display operation unit 206. FIG. 9 illustrates the display contents at this time.

FIG. 9 is a diagram illustrating a screen displayed on the display operation unit 206 when printing is performed in offline state. As illustrated in the display screen 901 of FIG. 9, the current number of prints (the total number of prints printed within the contract period), the upper limit number of prints, the remaining number of prints up to the upper limit number of prints, and the number of days since the apparatus was in offline state may be displayed by acquiring information from the contract data 420 and the number of prints data 421. When the user performs the confirmation operation (input of “1” in this example), the image processing apparatus 120 terminates the display of FIG. 9 and terminates the processing of this flowchart.

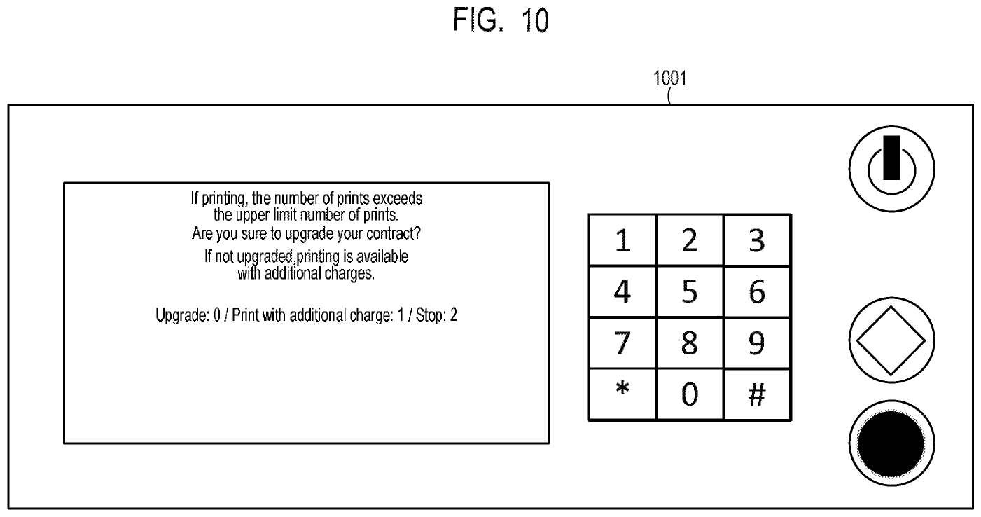

On the other hand, when the sum of the scheduled number of prints and the cumulative number of prints exceeds (reaches) the upper limit number of prints specified in the contract (No in step S706), the image processing apparatus 120 proceeds the processing to step S711. In step S711, the user interface 401 displays a screen for proposing a contract change to the display operation unit 206. FIG. 10 illustrates the contents displayed at this time.

FIG. 10 illustrates a screen displayed on the display operation unit 206 when the number of prints reaches the upper limit number of prints in offline state and a contract change is proposed. As illustrated in the display screen 1001 of FIG. 10, the user interface 401 indicates that the number of prints exceeds the upper limit, and causes the user to select (urge the user to select) whether to change the contract, continue printing by paying additional charges without changing the contract, or cancel printing. The contract change here indicates, for example, that when the user has a contract with plan A at present, the user changes the contract to plan B, which has a higher upper limit number of prints than plan A. Further, to continue printing by paying additional charges indicates that the upper limit number of prints in the current contract is increased only within the contract period. When the user makes any selection, the image processing apparatus 120 terminates the display of FIG. 10 and proceeds the processing to step S712.

In step S712, the image processing apparatus 120 determines whether the user has selected to change the contract. When the user has selected to change the contract (applied for contract change) (Yes in step S712), the image processing apparatus 120 proceeds the processing to step S714.

In step S714, the contract information management unit 410 of the image processing apparatus 120 updates the current contract information in the contract data 420 to the contents of the new subscription contract. At that time, information indicating that the contract contents have been changed in offline state is also added.

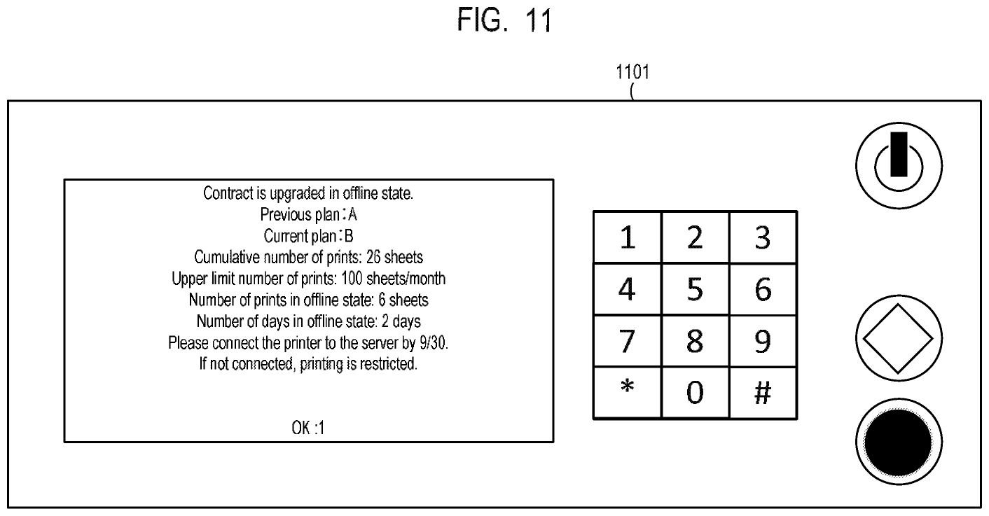

In step S715, the user interface 401 displays to the display operation unit 206 that the contract information has been updated. FIG. 11 illustrates the display contents at this time.

FIG. 11 is a diagram illustrating a screen displayed on the display operation unit 206 when the contract change is completed in offline state. As illustrated in the display screen 1101 of FIG. 11, the user interface 401 acquires and displays the information of the plan before the change and the plan after the change from the contract data 420. In addition, the current number of prints, the upper limit number of prints, and the number of days since the apparatus is changed to offline state may be acquired and displayed from the contract data 420 and the number of prints data 421, and a message urging the server to connect within a specific period after updating the contract is displayed. A specific period will be described later. When the user performs a confirmation operation (input of “1” in this example), the image processing apparatus 120 terminates the display of FIG. 11 and proceeds the processing to step S705.

On the other hand, if the user does not select to change the contract (No in step S712), the image processing apparatus 120 proceeds the processing to step S741. In step S741, the image processing apparatus 120 determines whether the user has selected to continue printing by paying additional charges. If the user has selected to continue printing by paying additional charges (applying for additional charges) (Yes in step S741), the image processing apparatus proceeds the processing to step S713.

In step S713, the contract information management unit 410 add the number of prints due to additional charge to the upper limit number of prints in the contract data 420, and also records information indicating that additional charging has been performed in offline state.

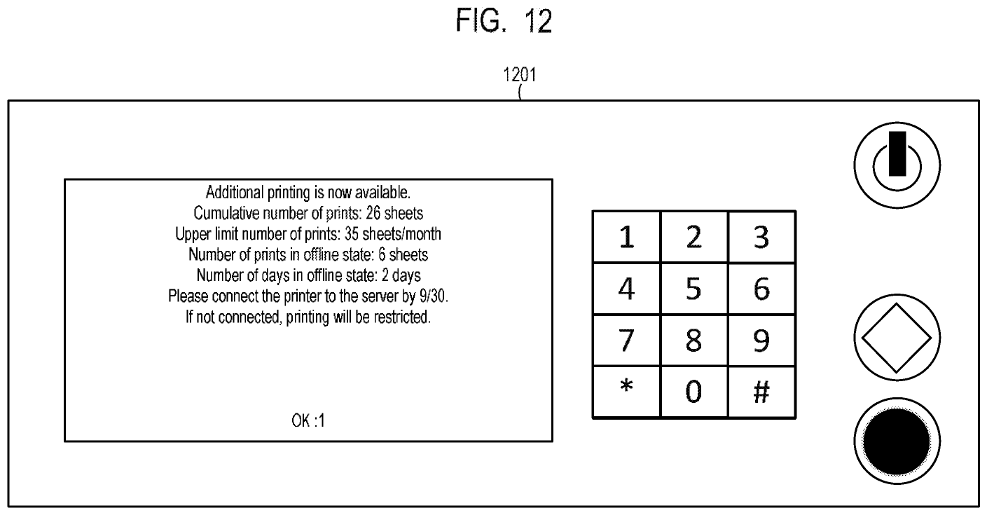

In step S716, the user interface 401 displays the upper limit number of prints after the additional charge has been performed to the display operation unit 206. FIG. 12 illustrates the display contents at this time.

FIG. 12 is a diagram illustrating a screen displayed on the display operation unit 206 when the additional charge procedure is completed in the offline state. As illustrated in the display screen 1201 of FIG. 12, the user interface 401 acquires and displays information on the upper limit number of prints changed by additional charges from the contract data 420. Furthermore, the current number of prints and the number of days since the apparatus was in offline state may be acquired from the contract data 420 and the number of prints data 421, and a message or the like is displayed so as to urge the server to connect within a certain period after additional charges. When a confirmation operation (input of “1” in this example) is performed by the user, the image processing apparatus 120 terminates the display of FIG. 12 and proceeds the processing to step S705.

On the other hand, when the user does not select to continue printing by paying additional charges in step S741 (No in step S741), that is, when the user selects to cancel printing, the image processing apparatus 120 proceeds the processing to step S742.

In step S742, the job control unit 403 cancels the print job received from the information terminal 110, and terminates the processing of this flowchart without counting up the number of prints data 421.

Next, the processing for determining whether the printer has returned to online state from offline state (determination processing of return from offline state to online state) will be described.

The flowchart 750 of FIG. 7B is a flowchart for explaining the details of the determination processing of return from offline state to online state in step S625 of FIG. 6, which corresponds to the process for determining whether the image processing apparatus 120 has returned from offline state to online state, and is repeatedly executed as long as the image processing apparatus is in the offline state.

First, in step S702, the image processing apparatus 120 determines whether a specific period has passed in a state in which the information of the contract data 420 has been rewritten during offline state (a state in which the contract has been changed or an additional charging has been performed during offline state) at steps S713 or S714 of the flowchart 700. The specific period here may be a fixed number of days (e.g., within a certain business day), or it may be determined that the contract period specified in the subscription contract has passed and the next contract period has come (e.g., the contract month has ended and the next month has come).

If the image processing apparatus 120 determined that the specific period has not yet passed (No in step S702), the image processing apparatus 120 proceeds the processing to step S703.

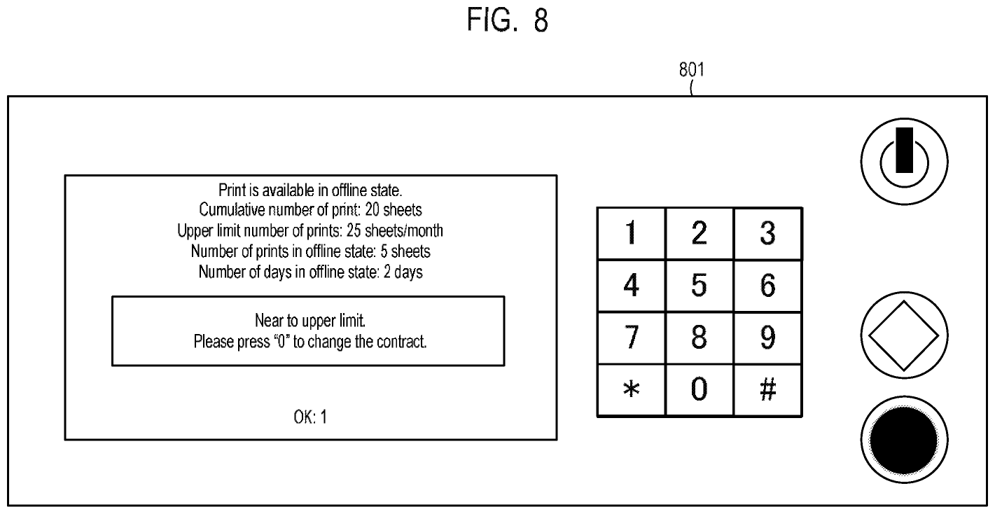

In step S703, the user interface 401 acquires information from the contract data 420 and the number of prints data 421, and displays the current contract information and the number of prints on the display operation unit 206. FIG. 8 illustrates the display contents at this time.

FIG. 8 is a diagram illustrating a screen displayed on the display operation unit 206 when the offline state is detected. As illustrated in the display screen 801 of FIG. 8, the user interface 401 may indicate that printing is available even when the printer is in offline state, and may display the current number of prints, the upper limit number of prints, and the number of days since the printer goes offline by acquiring information from the contract data 420 and the number of prints data 421. Furthermore, when the upper limit number of prints is near (for example, when the number of prints remaining up to the upper limit number of prints is less than the predetermined number of sheets), the printer may display this information and the operation method for changing the contract, and may alert the printer to change the contract.

After the processing of step S703, the image processing apparatus 120 proceeds the processing to step S701. The processing of step S701 and thereafter will be described later.

On the other hand, when the image processing apparatus 120 determined that a specific period has already passed since the contract changing or additional charging was performed in offline state (Yes in step S702), the image processing apparatus 120 proceeds the processing to step S731.

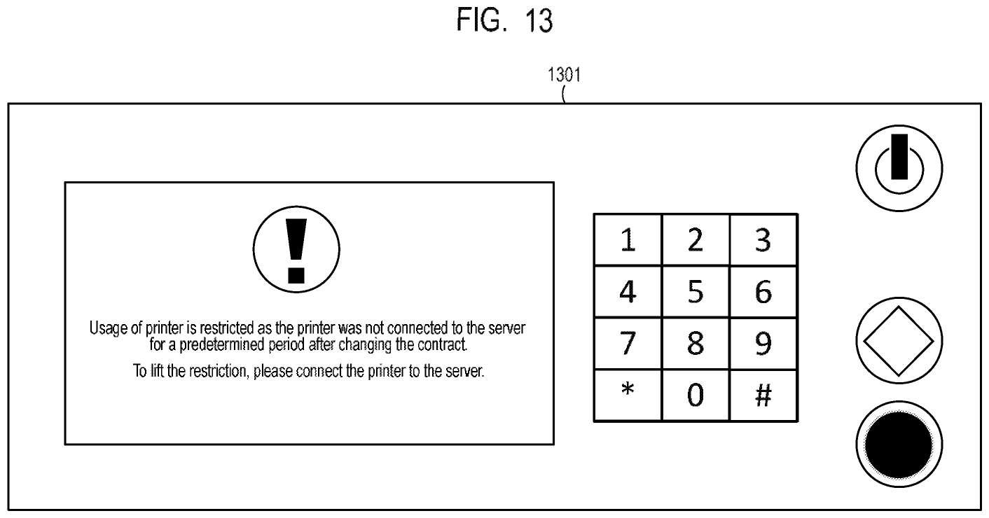

In step S731, in order to prevent the usage of the image processing apparatus 120 in the subscription mode, the user interface 401 locks the display operation unit 206 so that the display operation unit 206 cannot be operated and performs usage restriction. FIG. 13 illustrates the display contents at this time.

FIG. 13 is a diagram illustrating a screen displayed on the display operation unit 206 when the usage restriction is performed due to not connecting to the server for a certain period after a procedure of changing the contract or performing an additional charge in the offline state.

As illustrated in the display screen 1300 of FIG. 13, the user interface 401 specifies that the server was not connected for a specific period (which does not have to be a certain period) after the contract changing or additional charging, and prompts the user to connect to the server. Thereafter, the user interface 401 does not display anything other than the lock screen illustrated in FIG. 13 until the usage restriction is lifted.

As a result, since the user cannot operate the screen, changing the subscription contract or paying additional charges as illustrated in step S713 and S714 is not allowed, and the image processing apparatus 120 cannot be used. This process is a means for preventing the user from illegally trying to continue printing beyond the upper limit number of prints. Note that during this usage restriction, printing may be restricted even if the remaining number of prints that have already increased due to updating the subscription contract or paying additional charges. After the processing of step S731, the image processing apparatus 120 proceeds the processing to step S701.

In step S701, the image processing apparatus 120 determines whether or not the image processing apparatus 120 has returned from offline state to online state. In step S701, as step S612 of FIG. 6, the network communication unit 407 communicates with the server 111 to determine whether or not the communication reaches the server 111. If the communication does not reach the server 111, the offline state is assumed to have continued. On the other hand, if the communication reaches the server 111, the image processing apparatus 120 has been returned from offline state to online state.

If the image processing apparatus 120 determined that the offline state continues (No in step S701), the image processing apparatus 120 terminates the processing of this flowchart. On the other hand, if the image processing apparatus 120 determined that the image processing apparatus 120 has been returned from offline state to online state (Yes in step S701), the image processing apparatus 120 proceeds the processing to step S721.

In step S721, the image processing apparatus 120 synchronizes contract information with the server 111. Here, synchronization indicates matching contract information of the image processing apparatus 120 stored in the contract device information database 511 of the server 111 with the contents of contract data 420. For this purpose, the network communication unit 407 transmits the current contract information of the contract data 420 to the server 111. On the other hand, on the server 111 side, the contract device information management unit 503 updates the contract contents when the contract information received from the image processing apparatus 120 is newer than the contract device information database 511. Thus, the payment request amount according to the contract contents including additional charges is determined.

Next, in step S722, the user interface 401 updates the display contents of the display operation unit 206, and if the usage is restricted in step S731, the usage restriction is lifted, and terminates the processing of this flowchart.

In step S706 of the flowchart 700 of FIG. 7A, if the number of prints management unit 411 determines that the number of prints exceeds the upper limit number of prints at the time of inputting the print job, the contract update screen may not be displayed in step S711, but an additional charge may be automatically performed to continue printing. In this case, it is a condition that the user has agreed in advance that the additional charging will be automatically performed when the number of prints exceeds the upper limit number of prints specified by the contract. In this case, steps S711, S712, and S741 are omitted, and the processing proceeds from step S706 to step S713. However, the image processing apparatus 120 also prohibits this operation during the usage restriction described above. Note that although the user continued printing by paying an additional charge, the user may change the contract within the contract period and perform a procedure to increase the upper limit number of prints later.

As described above, even if the state of the image processing apparatus 120 is changed to be offline state in the subscription mode, the user is allowed to print sheets more than the upper limit number of prints by changing the contract or performing additional charges as in the online state. It is also possible to prevent the user from performing printing more than the upper limit number of prints illegally. Thus, it is possible to prevent the user from suffering inconvenience due to the upper limit number of prints while preventing the user from performing printing more than the upper limit number of prints illegally. That is, it is possible to achieve a balance between preventing illegal printing and improving usability.

### Second Embodiment

In the first embodiment described above, when the number of prints exceeds the upper limit number of prints of a subscription contract during printing process in offline state, printing is immediately continued by paying an additional charge or by changing the contract. On the other hand, although it is not inconvenient for the user that the apparatus is kept in offline state, it is not desirable for the operation to use the printer for a long time in offline state, and there is a possibility that the printer may be used in offline state without the user noticing. Even such a user may notice it by stopping printing and displaying it on the screen after printing a certain number of prints. In the second embodiment, a configuration which enables printing a certain number of prints after changing to offline state and makes it easy for the user to notice offline state without causing inconvenience will be described.

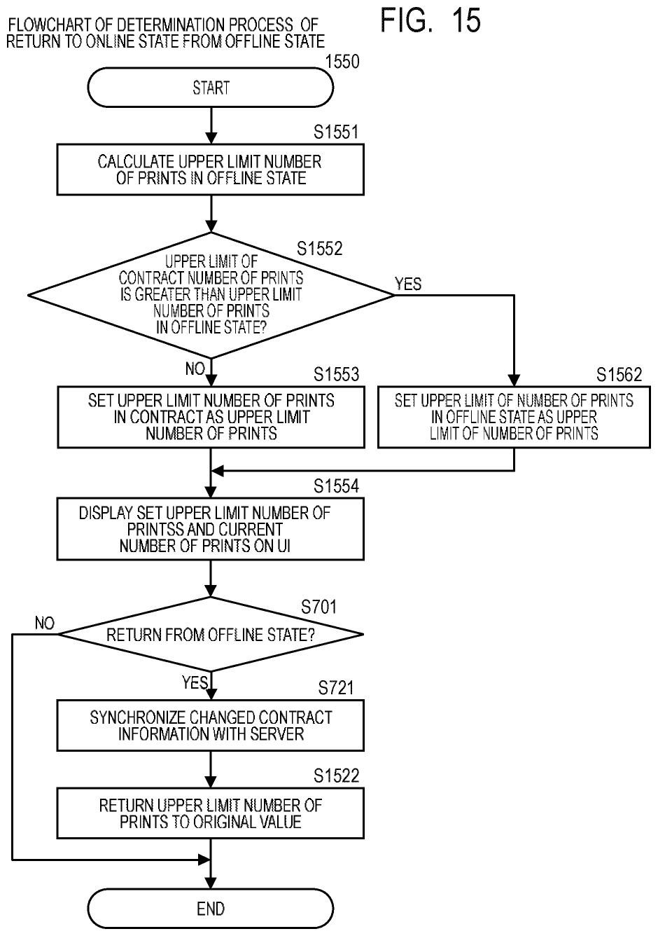

FIG. 15 is a flowchart for explaining the details of determination process of return from offline state in step S625 of FIG. 6, which corresponds to the process of determining whether the image processing apparatus 120 has returned from offline state to online state and is repeatedly executed as long as the image processing apparatus is in the offline state, similarly to FIG. 7B (750). The process illustrated in the flowchart of FIG. 15 is realized by the CPU 211 executing a program stored in one of the storage devices of the RAM 213, the storage 214, and the ROM 212 of the image processing apparatus 120. The same steps as flowchart 750 of FIG. 7B are assigned the same step numbers.

In the present embodiment, when the printer becomes offline state, the number of available print in offline state is applied. For example, it is assumed that the upper limit number of prints in the original subscription contract (referred to as the “upper limit number of prints in the contract” in the present embodiment) is 25 sheets per month, and 20 sheets have already been printed. It is also assumed that the available number of prints in offline state is four sheets. In this case, the upper limit number of prints in offline state (referred to as the “upper limit number of prints in offline state” in the present embodiment) is 24 sheets, which is 4 sheets added to the current 20 sheets.

First, in step S1551, the number of prints management unit 411 acquires the number of prints applied at the time of transition to the offline state from the ROM 302, and calculates the upper limit number of prints in offline state by adding the acquired number of prints to the current number of prints stored in the number of prints data 421.

Next, in step S1552, the number of prints management unit 411 acquires upper limit number of prints in the contract stored in the contract data 420, and compares it with the upper limit number of prints in offline state previously calculated. As a result of the comparison, the value to be applied as the upper limit number of prints is the smaller value. Here, when the value of the upper limit number of prints in the contract is larger than the value of the upper limit number of prints in offline state (Yes in step S1552), the number of prints management unit 411 proceeds the processing to step S1562.

In step S1562, the number of prints management unit 411 sets the upper limit number of prints in offline state to the temporary upper limit number of prints in the contract data 420. The number of prints management unit 411 simultaneously stores that the upper limit number of prints number in offline state is temporarily applied to the contract data 420.

On the other hand, if the value of the upper limit number of prints in offline state is not larger than the value of the upper limit number of prints in the contract (No in step S1552), the number of prints management unit 411 proceeds the processing to step S1553.

In step S1553, the number of prints management unit 411 leaves the upper limit number of prints in the contract in the contract data 420 set to the upper limit number of prints in the contract.

After the processing in steps S1553 or S1562, the image processing apparatus 120 proceeds the processing to step S1554.

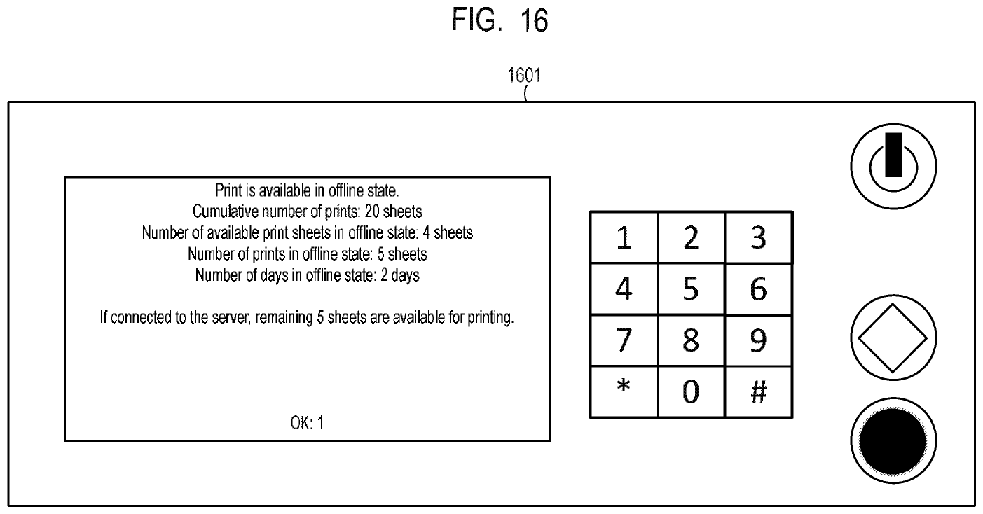

In step S1554, the user interface 401 displays information about the upper limit number of prints set in steps S1553 or S1562 and the current number of prints on the display operation unit 206. FIG. 16 illustrates the display contents at this time.

FIG. 16 is a diagram illustrating a screen displayed on the display operation unit 206 in the offline state in the second embodiment. As illustrated in the display screen 1601 of FIG. 16, the user interface 401 displays the difference between the upper limit print number applied to the contract data 420 and the current number of prints as the remaining number of available print sheets, and when the upper limit number of prints in the offline state is set, displays the number of available print sheets in the offline state. Furthermore, the number of available print sheets may be displayed when the upper limit print number in the contract is applied.

After the processing at step S1554, the image processing apparatus 120 proceeds the processing to step S701. Steps S701 and S721 are the same processing as the flowchart 750 of FIG. 7B, so the description thereof will be omitted.

After the processing at step S721 is carried out online, the image processing apparatus 120 proceeds to step S1522. In step S1522, the number of prints management unit 411 sets the upper limit print number applied during the offline state to the upper limit print number in the original contract, and terminates the process of this flowchart.

As described above, even if the image processing apparatus 120 is in the offline state, a certain number of prints can be available, thereby suppressing inconvenience to the user. In addition, by the display illustrated in FIG. 16, it is possible for the user to notice and respond to the fact that the image processing apparatus is in offline state after a certain number of prints, thereby preventing the image processing apparatus from being offline for a long period. As a result, it is possible to prevent the user from suffering inconvenience due to the upper limit number of prints while preventing the image processing apparatus from illegally printing more than the upper limit number of prints. That is, it is possible to achieve a balance between preventing illegal printing and improving usability.

### Third Embodiment

In the first and second embodiments described above, it was possible to change the contract offline. On the other hand, it is conceivable that the contract may be canceled unilaterally after printing by increasing the upper limit number of prints in offline state to avoid the payment request. In the third embodiment, a configuration in which the subscription contract cannot be canceled while the subscription contract remains offline even if the subscription contract is canceled to return to the normal use mode will be described.

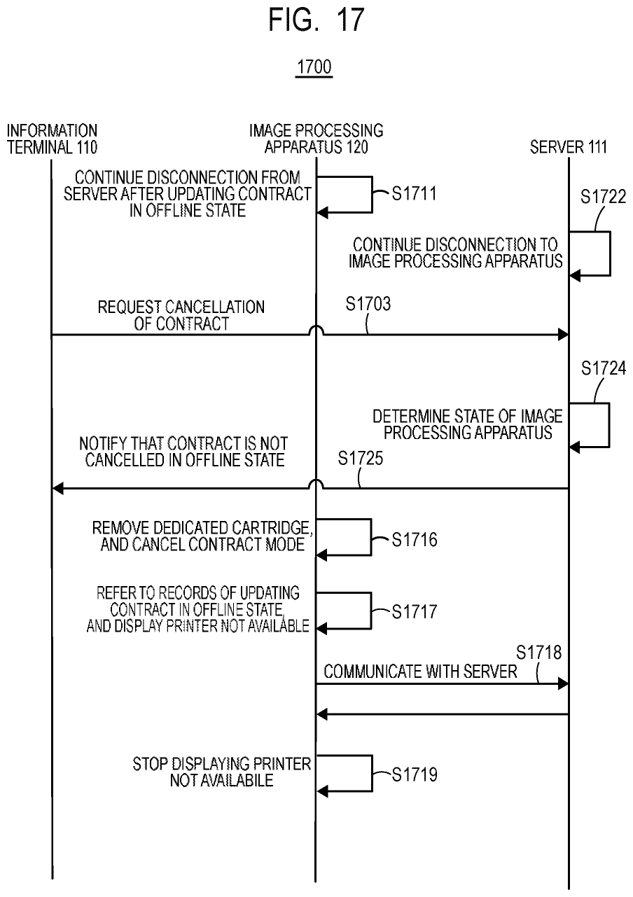

FIG. 17 is a sequence diagram illustrating a flow of processing between the information terminal 110, the image processing apparatus 120 and the server 111 in the third embodiment. FIG. 17 corresponds to a flow of processing when the information terminal 110 and the server 111 request cancellation of the contract, but the cancellation of the contract becomes impossible because the image processing apparatus 120 is not connected to the server 111.

Each processing of the information terminal 110 is realized by executing a program stored in one of the storage devices of the RAM 303, the storage 304, and the ROM 302 of the information terminal 110 by the CPU 301 of the information terminal 110. Each processing of the server 111 is realized by executing a program stored in one of the storage devices of the RAM 303, the storage 304, and the ROM 302 of the server 111 by the CPU 301 of the server 111. Each processing of the image processing apparatus 120 is realized by executing a program stored in one of the storage devices of the RAM 213, the storage 214, and the ROM 212 by the CPU 211.

In the sequence 1700, in step S1711, the image processing apparatus 120 is in offline state in which the image processing apparatus 120 is not connected to the server 111, and the contract data 420 is in a state in which the contract is changed or an additional charge is executed in offline state. On the other hand, in step S1722, the server 111 is in a state in which communication with the image processing apparatus 120 is interrupted and the state of the image processing apparatus 120 cannot be acquired.

In this state, when the user operates the information terminal 110 from the web browser of the information terminal 110 to request the server 111 to cancel the subscription contract in step S1703, the information terminal 110 transmits the request to cancel the contract to the server 111.

In step S1724, when the request processing unit 502 of the server 111 receives the request to cancel the subscription contract from the web browser of the information terminal 110, the request processing unit 502 checks the connection state with the image processing apparatus 120. The checking method here may be a method in which the network communication unit 504 attempts to request the image processing apparatus 120 to acquire the state to check whether the connection can be made. Alternatively, the last received date and time of the image processing apparatus 120 in the contract device information database 511 may be referenced to determine whether communication has been performed within a predetermined number of days. Here, it may be determined that the image processing apparatus 120 is not connected based on a communication failure of the network communication unit 504 or the received date and time of the contract device information database 511 being older than a specified number of days.

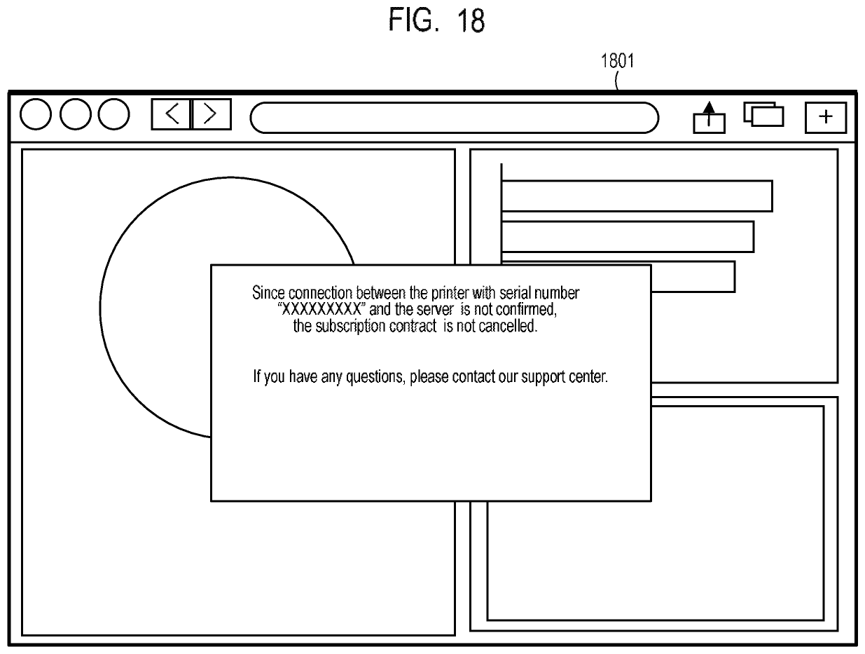

If the connection with the image processing apparatus 120 cannot be confirmed, in step S1725, the network communication unit 504 of the server 111 responds to the information terminal 110 to the effect that it cannot accept the request in step S1703 (request to cancel the subscription contract). Upon receiving the response, the user interface 401 of the information terminal 110 displays information based on the response on the web browser of the display unit 310. FIG. 18 illustrates the display contents at this time.

FIG. 18 is a diagram illustrating a screen displayed on the display unit 310 of the information terminal 110 when the cancellation of the subscription contract of the image processing apparatus 120 in the offline state in the third embodiment is performed on the website of the server 111.

As illustrated in the display screen 1801 of FIG. 18, the user interface 401 displays that the cancellation of the subscription contract cannot be performed because the image processing apparatus 120 cannot connect with the server 111.

As another procedure for cancelling the subscription contract, the ink cartridge of the image processing apparatus 120 may be replaced with a normal cartridge from a dedicated cartridge for subscription. It is assumed that the image processing apparatus 120 of present embodiment supports both the dedicated cartridge corresponding to the subscription contract and the normal cartridge not corresponding to the subscription contract as a cartridge containing a recording agent such as ink or toner. Then, it switches to the subscription mode according to the installation of the dedicated cartridge, and switches from the subscription mode to the normal mode according to the exchange from the dedicated cartridge to the normal cartridge.

After the contract is changed in the offline state, if the cartridge of the image processing apparatus 120 is changed to the normal use mode and can be used, the user will not be charged after the contract is updated. Therefore, when the ink management unit 412 detects in step S1716 that the user has replaced the dedicated cartridge with the normal cartridge, the process proceeds to step S1717.

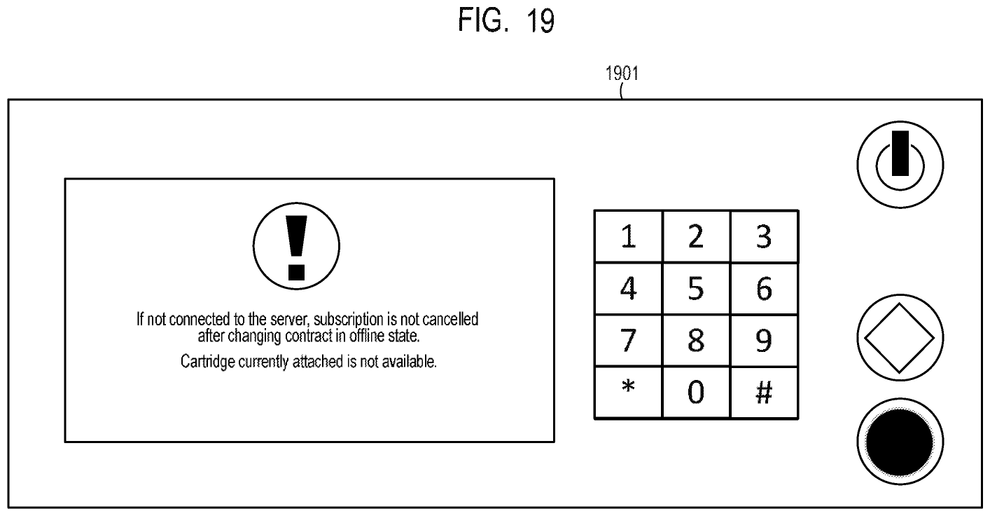

In step S1717, the image processing apparatus 120 refers to the record in which the contract information has been changed in offline state, and when the record changed in offline state is stored in the contract data 420, the user interface 401 displays that the usage of the display operation unit 206 is restricted. FIG. 19 illustrates the display contents at this time.

FIG. 19 is a diagram illustrating a screen displayed on the display operation unit 206 of the image processing apparatus 120 when a contract cancellation is attempted after changing the contract or paying additional charges in offline state in the third embodiment.

As illustrated in the display screen 1901 of FIG. 19, the user interface 401 displays that the subscription contract cannot be cancelled until the server is connected because the contract has been changed offline, and that the replaced normal cartridge cannot be used.

Thereafter, in step S1718, when the user connects the image processing apparatus 120 to the communication line 101 and the image processing apparatus 120 confirms that communication with the server 111 has resumed, the process proceeds to step S1719.

In step S1719, the user interface 401 withdraws the message displayed in step S1717 (the display contents illustrated in FIG. 19) and changes it so that it can be used normally. At this time, the contract information management unit 410 deletes the record of changing the contract in the offline state stored in the contract data 420 and synchronizes the contract data 420 with the contract device information database 511 of the server 111. Since the request for the contract period until the contract cancellation is calculated based on the contract device information database 511, the user can be requested to pay appropriately including the change in the offline time of the contract.

That is, in the image processing apparatus 120, when the subscription mode is canceled and the user switches to the normal use mode without being connected to the server 111 after changing the contract or paying additional charges is performed in offline state, the image processing apparatus is not available (not available state). Thereafter, when the image processing apparatus 120 is connected to the server 111, the “not available state” is canceled and the user transitions to the available state.

As described above, it is possible to prevent the user from canceling the contract without being connected to the server after the contract is changed in offline state, to appropriately reflect the contents of the contract change in the database of the server, and to request the user.

### Fourth Embodiment

In the first, second, and third embodiments described above, the usage of the printer is restricted if the printer is not connected to the server for a specific period after the contract is changed in offline state. However, it is also assumed that the connection becomes impossible due to a problem on the server side. In the fourth embodiment, a configuration in which the usage restriction is canceled for a certain period when a problem occurs on the server side and the contents of the contract change in offline state cannot be reflected on the server will be described.

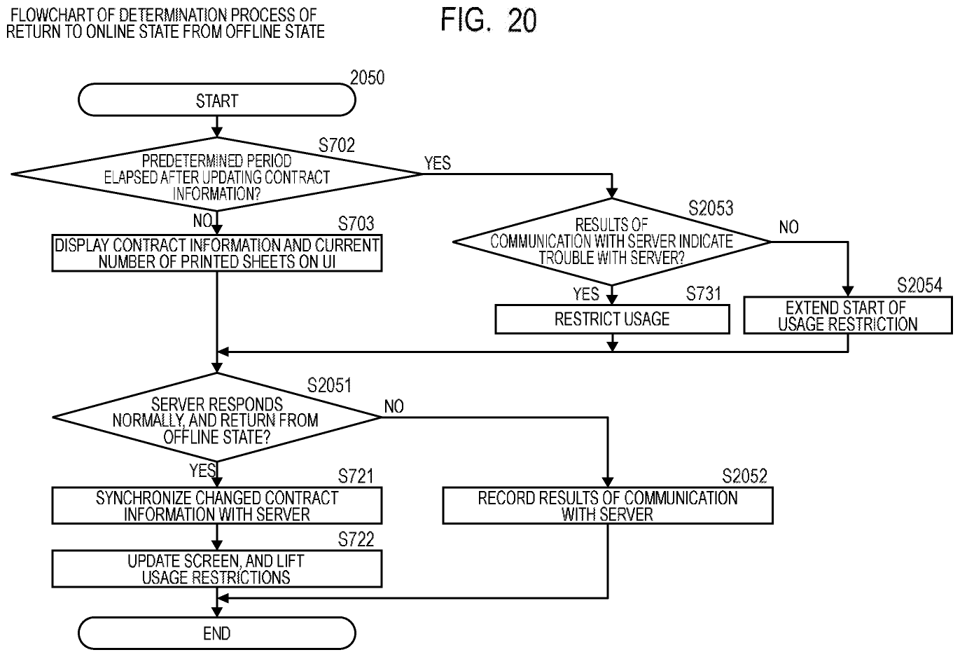

FIG. 20 is a flowchart for explaining the details of the determination process of return from offline state to online state in step S625 of FIG. 6, which corresponds to the process for determining whether the image processing apparatus 120 has returned from offline state to online state and is repeatedly executed as long as the image processing apparatus is in the offline state, similarly to the flowchart 750 of FIG. 7B. The process illustrated in the flowchart of FIG. 20 is realized by the CPU 211 executing a program stored in one of the storage devices of the RAM 213, the storage 214, and the ROM 212 of the image processing apparatus 120.

Here, since it is different from the flowchart 750 in that determining whether the connection with the server is caused by the server when the connection with the server cannot be made, and in that case, the usage is not restricted, only that part will be described below. The same steps as flowchart 750 of FIG. 7B are assigned the same step numbers.

In the present embodiment, for example, a specific period has not yet passed since changing the contract or paying additional charges was performed in offline state (No in step S702), and after the current contract information and the number of prints are displayed in step S703, the image processing apparatus 120 proceeds the processing to step S2051.

In step S2051, the network communication unit 407 attempts to communicate with the server 111, and determines whether or not the offline state has been returned to online state by a normal response from the server 111. When the server 111 returns a normal response and determines that the offline state has been returned to online state (Yes in step S2051), the network communication unit 407 proceeds the processing to step S721.

On the other hand, when the network is disconnected or an abnormal response is returned from the server (No in step S2051), the network communication unit 407 proceeds to S2052.

In the S2052, the network communication unit 407 records the communication record with the server in step S2051 in the storage 304 or RAM 303, and terminates the processing of this flowchart.

Here, a normal response from the server is a case in which a response code 200, which is a normal response, is returned when the HTTP protocol is used, while an abnormal response is a case in which a response code of the 500 series is returned. The network is disconnected is a case in which a connection request is made to the server 111, but no response is returned even after waiting for a certain timeout period specified in the image processing apparatus 120.

Then, when the processing illustrated in FIG. 20 is executed again after a certain period has elapsed since the changing the contract or paying additional charges was performed in offline state (Yes in step S702), and the processing proceeds to step S2053. In step S2053, the image processing apparatus 120 determines whether or not the server is abnormal based on the communication result with the server recorded in step S2052.

When it is determined that the network is disconnected (not a server abnormality) (No in step S2053), the job control unit 403 proceeds the processing to step S731 and displays a screen restricting the usage of the image processing apparatus 120 on the display operation unit 206.

On the other hand, when it is determined that the server abnormality is present (No in step S2053), the image processing apparatus 120 proceeds the processing to step S2054.

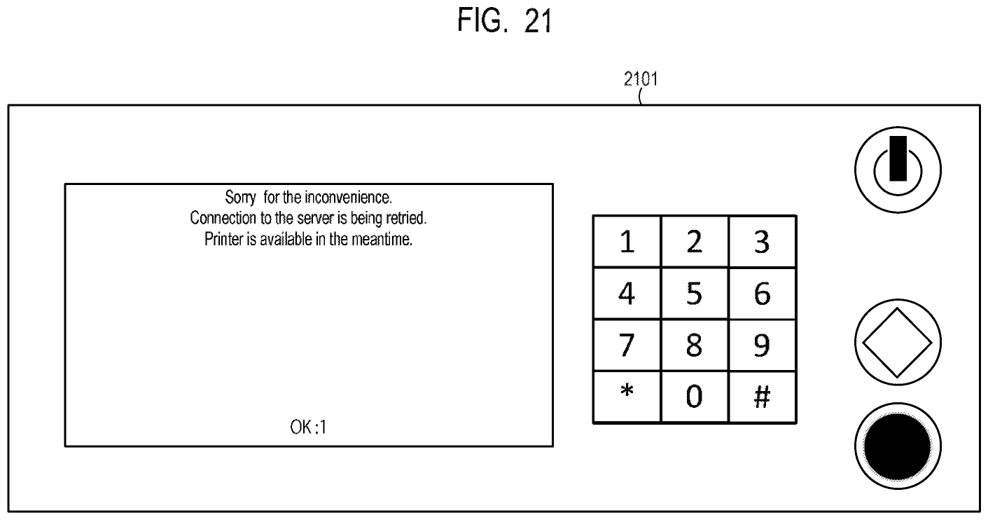

In step S2054, the usage of the image processing apparatus 120 should be restricted if the contract device information database 511 of the server 111 and the contract data 420 of the image processing apparatus 120 cannot be synchronized within a specific period, but the connection cannot be made due to server factors. In this case, the start of the printing restriction by the job control unit 403 is set to be postponed so as not to cause inconvenience to the user due to problems on the server side. At this time, the user interface 401 displays that it is available to the display operation unit 206. FIG. 21 illustrates the display contents at this time.

FIG. 21 is a diagram illustrating a screen displayed on the display operation unit 206 when the usage restriction is postponed without connection due to server factors after changing the contract or paying additional charges in the offline state in the fourth embodiment. Here, as in the display screen 2101 of FIG. 21, it is displayed that the image processing apparatus 120 can be used because it is not connected to the server but is caused by a server abnormality.

After the processing in step S2054, the image processing apparatus 120 proceeds the processing to step S2051 again. In step S2051, the network communication unit 407 attempts to connect to the server 111, and when a normal response is returned and proceeds the processing to steps S721 and S722, and the user interface 401 cancels the display of the display screen 2101 displayed in the display operation unit 206.

As described above, the usage of the image processing apparatus 120 is restricted when the user is illegally disconnected from the network, but the usage can be continued so as not to cause inconvenience to the user when the server cannot respond normally. That is, it is possible to achieve a balance between preventing illegal printing and improving usability.

### Fifth Embodiment

In the first embodiment described above, a method for changing a contract from an image processing apparatus even if the image processing apparatus is in offline state has been described, but it is also possible for a user to access a website to perform a procedure for changing a contract. As a method for easily accessing the website, an example of reading a two-dimensional barcode (also referred to as a two-dimensional code) that can be read by a camera of a portable terminal to access the website will be described below.

In step S711 of the flowchart 700 illustrated in FIG. 7A in the first embodiment, the user interface 401 displays a display like the display screen 1001 illustrated in FIG. 10 to the display operation unit 206 and proposes a change of the contract on the screen.

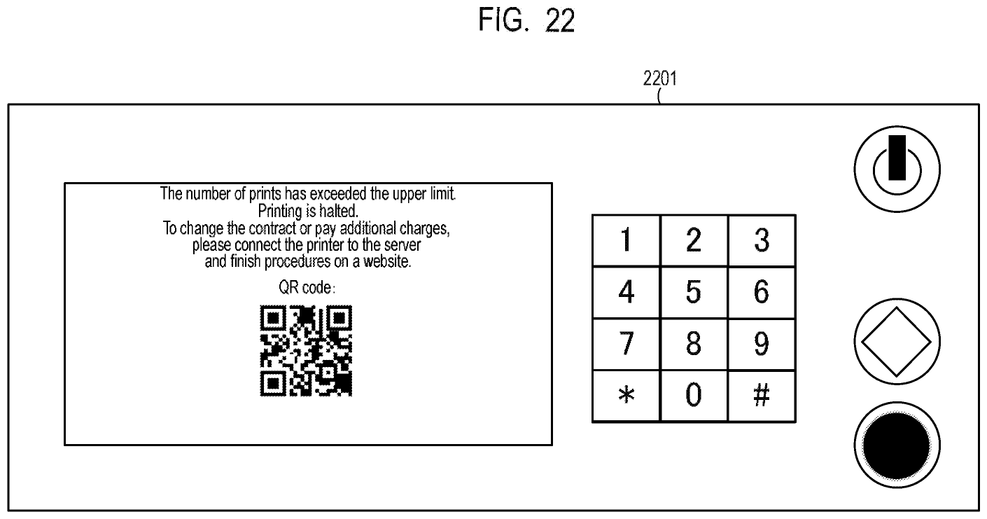

In the fifth embodiment, instead of the display screen 1001 illustrated in FIG. 10, the display screen 2201 illustrated in FIG. 22 is performed.

FIG. 22 is a diagram illustrating a screen for displaying a two-dimensional barcode for accessing a website of the server displayed on the display operation unit 206 when the upper limit number of prints is reached in the offline state in the fifth embodiment.

Here, as in the display screen 2201 of FIG. 22, the user interface 401 displays a two-dimensional barcode (for example, a QR code ([registered trademark]) readable by a mobile terminal on the display operation unit 206, which can be read by the camera of the mobile terminal to access the website.

The two-dimensional barcode is stored in the storage 304 or RAM 303 by the user interface 401 as an image obtained by converting the URL of the website of the server 111 into a two-dimensional barcode, and is displayed in accordance with the display in step S711. The URL included in the two-dimensional barcode is, for example, the URL of a website for changing the above-mentioned subscription contract or for paying additional charges.

The user can read the two-dimensional barcode of the display screen 2201 by the camera of his/her portable terminal, access the website, and carry out the procedure for changing the contract. The two-dimensional barcode of FIG. 22 may be added to the display of FIG. 10.

As described above, even if the user cannot immediately access the website of the server, the user can immediately access the website by reading the two-dimensional barcode displayed on the display operation unit 206 by the portable terminal.

### Sixth Embodiment

In the sixth embodiment, when the user accesses the website of the server 111 from the portable terminal to perform the procedure for changing the contract by using the two-dimensional barcode of the fifth embodiment, information on the change of the contract is inputted to the image processing apparatus 120 to increase the upper limit number of prints while remaining offline.

For example, when the user accesses the website of the server 111 from the portable terminal to perform the procedure for changing the contract, the two-dimensional barcode is also included in the contract change completion screen responded to the portable terminal from the server 111. The two-dimensional barcode of the contract change completion screen includes, for example, a unique ID (serial number of the device) of the device, information on the changed contract contents and additional charges, and procedure-specific information (process ID, etc.).

In the present embodiment, a message such as “When you change the contract from the mobile terminal, set the contract change completion screen to the scanner and press “0”.” is also added to the display screen 2201 illustrated in FIG. 22.

In accordance with this message, the user sets the contract change completion screen displayed on the mobile terminal on the reading surface of the scanner 205 and performs an operation such as pressing “0” at the display operation unit 206 of the image processing apparatus 120. In accordance with this operation, the image processing apparatus 120 performs reading processing of the two-dimensional barcode of the contract change completion screen using the scanner 205.

When the image processing apparatus 120 reads the two-dimensional barcode of the contract change completion screen, the image processing apparatus performs processing of updating the subscription contract offline such as steps S714 and S713 and increase of the upper limit number of prints due to additional charge based on the information contained in the two-dimensional barcode. Then, the upper limit number of prints after the contract change and the additional charge are displayed such as steps S715 and S716.

When processing the increase of the upper limit number of prints, the image processing apparatus 120 performs a check based on the unique ID (device serial number) of the device and unique information (process ID, etc.) of the contract procedure included in the two-dimensional barcode of the contract change completion screen. At this time, the image processing apparatus 120 controls not to increase the upper limit number of prints when the unique ID of the device is different from its own ID and the unique information of the contract procedure has been used before.

Thus, it is possible to prevent the usage of the two-dimensional code for other image processing apparatus or the usage of the same two-dimensional code multiple times to increase the upper limit number of prints illegally.

It should be noted that the aforementioned contract completion information may be transmitted from the mobile terminal to the image processing apparatus via a communication route such as Bluetooth (registered trademark), NFC (near field communication) or USB interface.

As described above, even in the case of the offline state in the subscription mode, the two-dimensional barcode displayed on the display operation unit 206 can be read by the mobile terminal, accessed to the server 111, and the upper limit number of prints or more can be printed by changing the contract or paying additional charges, just as in the online state.

Traditionally, there has been a technology to prevent the usage of the server in such a state that charging or the like cannot be performed when the server communication is not performed, and to suppress unauthorized use. However, printing is limited and inconvenient even when communication with the server cannot be performed because the server itself is down, the communication line or Wi-Fi is out of order, etc. In particular, in the case of subscription services, a period of time during which printing cannot be performed significantly reduces user benefits. In addition, when a user prints more than the number of prints specified in the contract, the server can be asked to change the contract if the server can be connected. However, when the server cannot be connected, such as when the server is down, the server cannot be asked to change the contract, which is inconvenient for the user.

On the other hand, according to the above-described embodiments, even when the server cannot be connected, the function of the subscription service equivalent to the state in which the server can be connected can be used, and illegal use can be suppressed. Thus, the usability of the user using the subscription service can be greatly improved.

The structure and contents of the various types of data described above are not limited to this, and it is needless to say that they are composed of various structures and contents depending on the use and purpose.

Although one embodiment has been described above, the present disclosure may be realized as, for example, a system, an apparatus, a method, a program or a storage medium. Specifically, it may be applied to a system comprising a plurality of devices, or it may be applied to a device comprising a single device. In addition, all configurations combining the above embodiments are included in the present disclosure.

### Other Embodiment

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure may be applied to a system comprising a plurality of devices or an apparatus comprising a single device.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

According to the present disclosure, even when a connection with the server is not possible, the function of the subscription service equivalent to the state in which the connection with the server is possible can be used, and unauthorized use can be suppressed.

This application claims the benefit of Japanese Patent Application No. 2023-024364 filed on Feb. 20, 2023, which is hereby incorporated by reference herein in its entirety.

What is claimed is:

1. A printer for communicating with a server that manages contract information of a contract for permitting printing up to a predetermined upper limit number of prints corresponding a specified amount during a contract period, the printer comprising at least one processor and at least one memory storing instructions to be executed by the processor to cause the printer to operate as:
a first management unit that acquires and manages the contract information from the server;
a control unit that controls to perform printing based on the contract information;
a second control unit that manages cumulative number of prints within the contract period, a remaining number of prints up to the upper limit number of prints, the number of days since the printer has been in offline state with no connection to the server, and the number of prints in the offline state;
an alert unit that issue an alert message when the remaining number of prints up to the upper limit number of prints is less than a predetermined number;
a first display unit that, when the number of prints reaches the upper limit number of prints in the offline state, displays a screen for requesting to change the contract or to perform an additional charge for increasing the upper limit number of prints in the offline state;
an updating unit that updates the contract information managed by the first management unit in response to a request input via the screen;
a second display unit that displays a message indicating that the printer should be connected with the server within a certain business day or within the contract period in response to updating the contract information; and
a restriction unit that restricts printing when the server is not connected within the certain business day or within the contract period after updating the contract information.

2. The printer according to claim 1, wherein the processor further causes the printer to operate as a transmitting unit that transmits the updated contract information to the server when the printer is connected to the server after updating the contract information.

3. The printer according to claim 1, wherein when the printer is connected to the server while the printing is restricted, the restriction unit cancels the restriction of the printing.

4. The printer according to claim 1, wherein the processor further causes the printer to operate as a switching unit that switches between a first mode operating the printer based on the contract information and a second mode that is a mode being canceled the first mode, and
wherein the control unit controls the printer to be disabled when switching from the first mode to the second mode is performed without being connected to the server after updating the contract information.

5. The printer according to claim 4, wherein the processor further causes the printer to operate as an attaching unit that is enable to attach a first cartridge corresponding the contract or a second cartridge not corresponding the contract, the first cartridge and the s contain a recording agent, and
wherein the switching unit switches the mode to the first mode in response to attaching the first cartridge to the attaching unit, and switches the mode to the second mode in response to replacing from the first cartridge to the second cartridge at the attaching unit.

6. The printer according to claim 1, wherein even if the printer has not connected to the server within the specified business day or within the contract period after updating the contract information, the restriction unit postpones starting of the restriction on printing when no connection with the server is due to a problem at the server side.

7. The printer according to claim 1, wherein when the number of prints reaches the upper limit number of prints in the offline state, the first display unit displays information including a URL of the server and used for changing the contract or performing the additional charge.

8. The printer according to claim 7, wherein the processor further causes the printer to operate as a reading unit that reads response information of the server displayed on another device when the another device has changed the contract or performed the additional charge by connecting to the server, and
wherein the updating unit updates the contract information managed by the first management unit based on response information from the server read by the reading unit.

9. A method of controlling a printer that communicates with a server that manages contract information of a contract for permitting printing up to a predetermined upper limit number of prints corresponding a specified amount during a contract period, the printer comprising at least one processor and at least one memory storing instructions to be executed by the processor, the instructions comprising:
acquiring the contract information from the server;
calculating and saving cumulative number of prints within the contract period, a remaining number of prints up to the upper limit number of prints, the number of days since the printer has been in offline state with no connection to the server, and the number of prints in the offline state;
issuing an alert message saying that the remaining number of prints up to the upper limit number of prints is less than a predetermined number;
when the number of prints reaches the upper limit number of prints in the offline state, keeping the offline state and displaying a screen for requesting a change to the contract while the printer is in the offline state or requesting an additional charge for increasing the upper limit number of prints;
updating the contract information managed by a first management unit in response to a request input via the screen;
displaying a message indicating that the printer should be connected with the server within a certain business day or within the contract period in response to updating the contract information; and
restricting printing when the server is not connected within the certain business day or within the contract period after updating the contract information.
